(19) United States
(12) Patent Application Publication
(10) Pub. No.: US 2014/0257806 A1
(43) Pub. Date: Sep. 11, 2014

(54) FLEXIBLE ANIMATION FRAMEWORK FOR CONTEXTUAL ANIMATION DISPLAY

(71) Applicant: NUANCE COMMUNICATIONS, INC., Burlington, MA (US)

(72) Inventors: Elizabeth Ann Dykstra-Erickson, San Francisco, CA (US); Eric A. Wilson, Kenmore, WA (US); Matthieu Hebert, Melocheville (CA)

(73) Assignee: NUANCE COMMUNICATIONS, INC., Burlington, MA (US)

(21) Appl. No.: 13/786,397

(22) Filed: Mar. 5, 2013

(51) Int. Cl. G10L 21/10

(52) U.S. Cl. CPC G10L 21/10
USPC 704/235

(57) ABSTRACT

A method of providing a custom response in conjunction with an application providing speech interaction is described. In one embodiment, the method comprises determining a context of a current interaction with the user, and identifying an associated custom animation, when the associated custom animation exists. The method further comprises displaying the custom animation by overlaying it over a native response of the application. In one embodiment, when no custom animation exists, the method determines whether there is a default animation, and displays the default animation as part of a state change of the application.

### FIELD

The present invention is related to contextual displays, and in particular to providing a framework for contextual displays.

### BACKGROUND

Animations are often used in user interface features. For example, an icon when selected may blink or in some other way indicate it has been selected. Similarly, animations may be used as a feedback mechanism to the user, e.g. highlighting an icon when selected, or providing a tone to indicate that a transaction has been successfully executed.

In general, an animation is related to the application or user device's current state.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a network diagram of one embodiment of a system including a device with a task assistant.

FIG. 2 is a block diagram of one embodiment of a state-based flexible animation framework system.

FIG. 3 is an overview flowchart of using the task assistant with the flexible animation framework.

FIG. 4A is a state diagram illustrating an exemplary set of default animations for each state.

FIG. 4B is a diagram illustrating an exemplary custom animation available in a particular state.

FIG. 5 illustrates some exemplary custom response types, and custom responses.

FIG. 6 is a flowchart of one embodiment of designing a custom response.

FIG. 7 is a block diagram of one embodiment of a computer system that may be used with the present invention.

### DETAILED DESCRIPTION

The system provides a custom response, to provide visual, auditory, and verbal indication of state to users as they engage in speech interactions. In one embodiment, five states of the speech system exist with corresponding state animations. Note that the term “animations” is intended to encompass all non-content communications with the user including visual, auditory, haptic, and a communication including a combination of one or more of those formats. In addition to these state animations, the system enables the provision of additional animation triggers based on a variety of factors. The system permits flexible assignment of base animations, emphasis animations, and vanity animations.

The system provides standardized but customizable state representations, with additional overlay animations that provide feedback tuned to a more granular level. For example, a default state representation for a successful transaction is a bounce of the icon and associated non-verbal announcements. An exemplary more granular success indicator could be tuned to a specific data event such as ‘Your team won!’ and include coloring and team brand element. Another exemplary more granular success indicator could be tuned to a specific type of successful transaction, such as a deposit having been received, and could include a branded piggy bank, and the sounds of coins dropping into it. This provides additional emotional impact and a more granular feedback tuned to a specific utterance under specific conditions. This generalizes to emotive response categories and can be specific to the degree the implementation so instructs.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

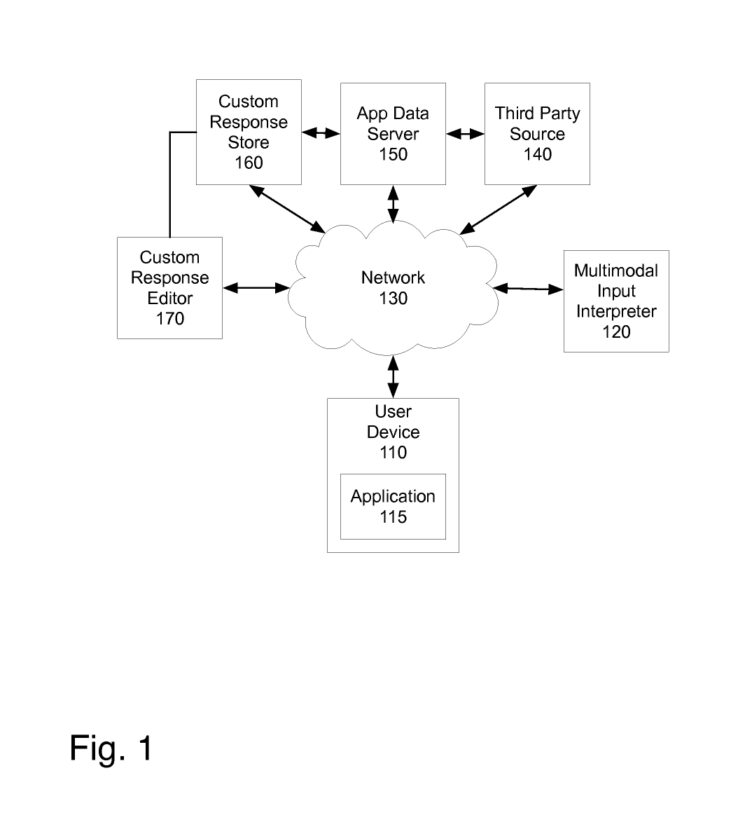

FIG. 1 is a network diagram of one embodiment of a system including a device with a task assistant. The system includes a user device 110, with an application 115. The application 115 may be a task assistant or similar application residing on the user device 110 providing certain interface features. In one embodiment, the task assistant 115 provides multimodal input and output features. In one embodiment, the application 115 interfaces with an application data server 150, and a multimodal input interpreter 120. The application 115 in one embodiment, provides data to and receives data from application data server 150 and/or third party source 140, through network 130. The network 130 may be the Internet, accessed via a wireless connection, a cellular network connection, a wired connection, or other connection mechanism.

In one embodiment, the user device 110 is a smartphone or tablet device. The user device 110 includes a plurality of applications 115, in one embodiment, at least one of which interfaces with external systems, such as server 150, 140, or 120.

In one embodiment, multimodal input interpreter 120 is a server which receives multimodal input data from application 115 and/or device 110, and interprets the input. The multimodal input interpreter 120 may provide the interpreted input back to application 115 or device 110, or may provided it to application data server 150.

In one embodiment, application 115 provides animated feedback to the user, when the user interacts with the application 115. Such feedback may include tones, images, or other information, displayed upon successful and unsuccessful interactions, or at other stages of the communication.

In one embodiment, the application 115 includes one or more such animated feedback features. In one embodiment, in addition to default feedback, the application 115 may also include custom feedback animations. In one embodiment, custom feedback animations may be included with the application 115 when it is acquired, provided by the application data server 150, or downloaded from a custom response store 160. In one embodiment, such custom responses may be created, using custom response editor 170. In one embodiment, the created custom responses may be pushed to applications, made available for users to download to applications, or be incorporated in applications, as they are released or updated.

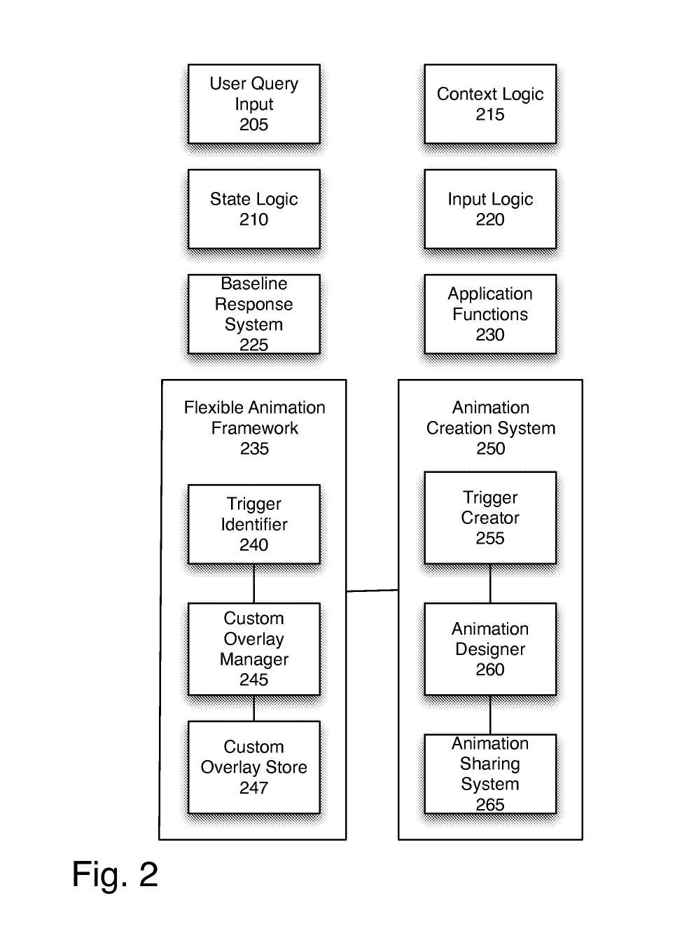

FIG. 2 is a block diagram of one embodiment of an application and a system to implement the flexible animation framework. The system includes a state logic 210, to maintain the current state of the application. The application, in one embodiment, has a limited number of states, each reflecting a current activity being performed by the application. In one embodiment, the states include states reflecting that the application is awaiting input, receiving input, processing input, or responding to the input. In one embodiment, the responding to the input may include a mode that includes responding to correctly framed and processed input, e.g. providing the requested results to the user, or responding indicating that the input was not properly processed, and communicating how to fix this issue.

Context logic 215, in one embodiment, maintains the context of the previous user inputs and responses. This enables the user input, received through user query input 205 to be simplified. By not needing to provide the entire context, the user may be able to communicate more clearly with the system.

Based on the current state, the user input, and the context, the input logic 220 determines the meaning of the user input. The input is used to provide the application functions 230. The application functions may include various communicating to a remote server, processing user input, receiving a response from a remote server, or otherwise providing a response to the user's query.

In addition to the interpreted input being used by application functions 230, the data is passed to the baseline response system 225. The baseline response system provides an animated response, when appropriate. For example, if the user's input is interpreted, and passed to a remote server for a response, the baseline response may provide an indication. In one embodiment, the baseline response system 225 provides a response to each state for the system, as indicated by state logic 210. For example, the processing state, the response state, and the listening state may each be indicated with a corresponding animation.

In one embodiment, additional there is a flexible animation framework 235 present in the system. The flexible animation framework 235 provides additional overlay animations that provide feedback tuned to a more granular level. For example, a default state representation, provided by baseline response system 225, for a successful transaction is a bounce of the icon and associated non-verbal announcements. The more granular representation, provided as an overlay by the flexible animation framework 235, may have the sound of coins clinking when a deposit transaction is completed.

In one embodiment, flexible animation framework 235 includes a trigger identifier 240. Trigger identifier utilizes a combination of the interpreted input and the state to identify an appropriate custom overlay animation. The custom overlay manager 245 displays the identified overlay animation, from custom overlay store 247 when appropriate. By providing such granular animations as an overlay, the application need not have additional states, and can be provided with specific customized animations, for any application. For example, the animation for an application providing notifications about banking transactions may be different from the animations associated with a travel application. By utilizing the flexible animation framework 235, the same baseline design may be used.

In one embodiment, in addition to allowing the addition of custom overlays, custom overlay manager 245 also monitors the custom overlays, and selects among overlays when trigger identifier identifies multiple potential overlays. In one embodiment, the multiple overlays may be displayed simultaneously, if their features do not interfere (e.g. one providing a visual and the other a tone). In one embodiment, custom overlay manager 245 selects the animation to display. In one embodiment, the custom overlay manager 245 also monitors the custom overlays in storage 247, to ensure that any expired overlays are removed. In one embodiment, an overlay may have an expiration date associated with it.

In one embodiment, the system may include an animation creation system 250. The animation creation system 250 may reside on a separate server, on the mobile device, or in a customer application available via a computing device. The animation creation system 250 includes a trigger creator 255, which enables a user to define a trigger that would initiate the custom animation. For example, the trigger may include an application state and the interpretation of the user query and context. The animation designer 260 enables the design of the animation itself. The animation may include visual, aural, and haptic elements, in one embodiment. In one embodiment, the animation may have a temporal aspect as well. In one embodiment, the user would need to define the timing of the animation, with respect to the trigger, and the length of animation.

In one embodiment, the system may also include an animation sharing system 265. The animation sharing system 265 enables a user to share his or her animations. In one embodiment, the user that can design an animation and share it may be the owner of the application. In one embodiment, the animation sharing system 265 may make the animation available on a server, may push the animation to installed applications, or may make the animation available for access to the application.

In one embodiment, any user may design a custom animation. In one embodiment, any user designed custom animations may need to be approved by the application owner before being made available to other users. In one embodiment, the animation sharing system is controlled by the application owner.

In this way, the system provides a flexible animation framework, and enables an application to present a more interesting and involving user interface to the user, without creating additional complexity in the application itself. Additionally, it enables reuse of the underlying application, while providing a custom front-end without making a change to the underlying application.

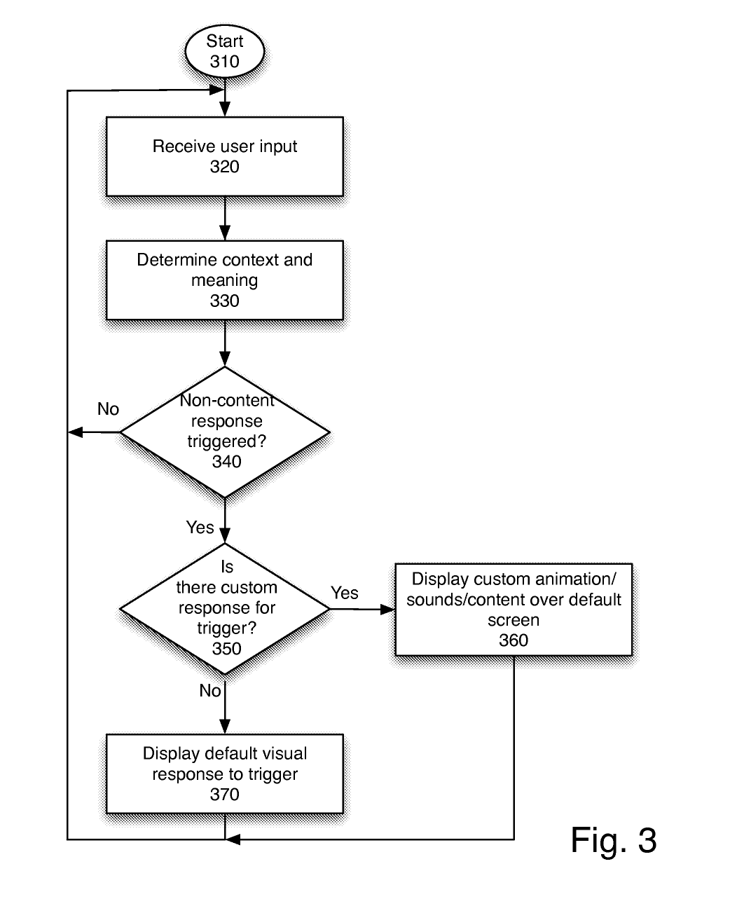

FIG. 3 is an overview flowchart of using the task assistant with the flexible animation framework. The process starts at block 310. At block 320, user input is received. The user input may be multimodal input, including writing, talking, or gesture-based input.

At block 330, the process determines the context and meaning of the user input. In one embodiment, the context provides additional information for interpreting the user input.

At block 340, the process determines whether a non-content response is triggered. A non-content response is a feedback response that does not provide direct information, such as an animation, including a change in the image or sound. If no non-content response is triggered, the user input is handled as normal, and the process returns to block 320.

If a non-content response is triggered, at block 350 the process determines whether the trigger has an associated custom response. A custom response is a more granular response than a default response to the user input. For example, the default response may be a spinning icon to indicate that the system is processing the user's request. The custom response may flash the icon with the application's icon, or make an appropriate sound.

If there is no custom response, at block 370 the default visual response to the trigger is displayed.

If there is a custom response, as determined at block 350, at block 360, the custom animation is displayed over the default screen. In one embodiment, the custom response is displayed over the default response, such that the default response is (invisibly) displayed but covered by the custom response. This enables the system to utilize the custom response without modification of the default responses. In one embodiment, if multiple custom responses may be triggered, the system determines which response(s) to display. In one embodiment, the custom responses may be designed not to conflict, e.g. each custom response providing a different aspect of the animation. For example, the wallpaper, the image of the icon, and the sound played may be controlled by different custom overlays. In one embodiment, if there is a conflict between the possible custom overlays, the highest priority response is displayed. In one embodiment, the application owner may prioritize the custom overlays. In one embodiment, the most recently obtained overlay is set as the highest priority. In one embodiment, if one or more of the overlays has an expiration date, the overlay with the earliest expiration date is set to be the highest priority. The process then returns to block 320.

Note that while this is illustrated as flowchart in which the process returns to block 320, in one embodiment, the process may move to a state in which the application does not continue to monitor for user input, without altering the meaning of the process.

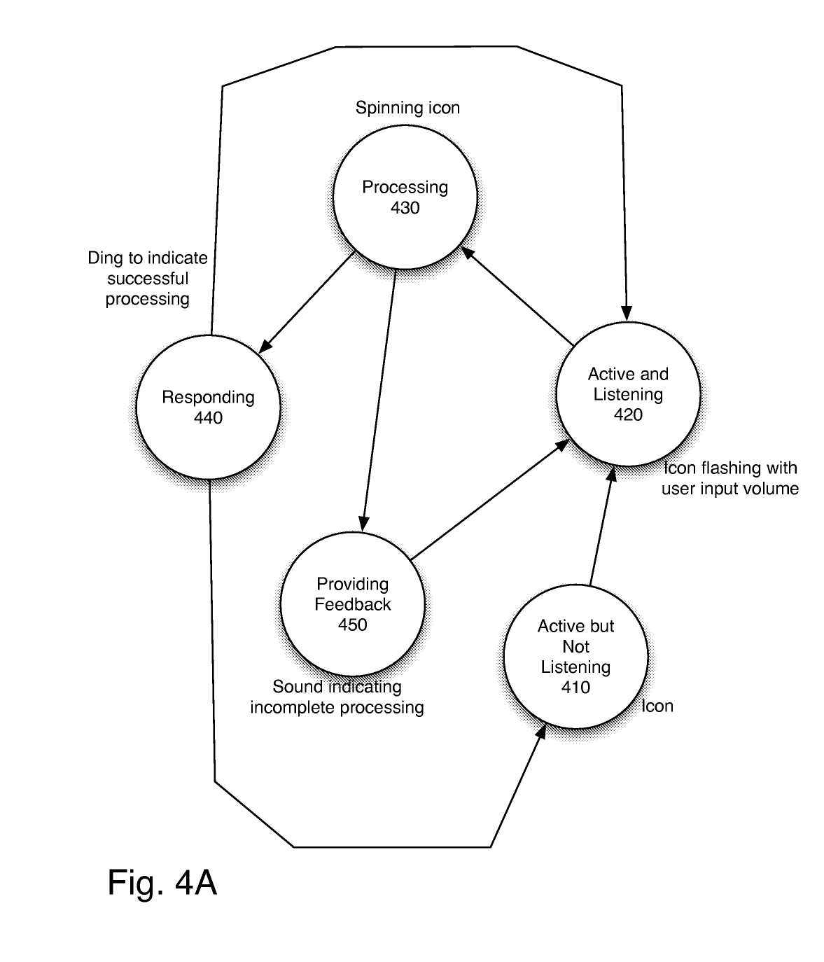

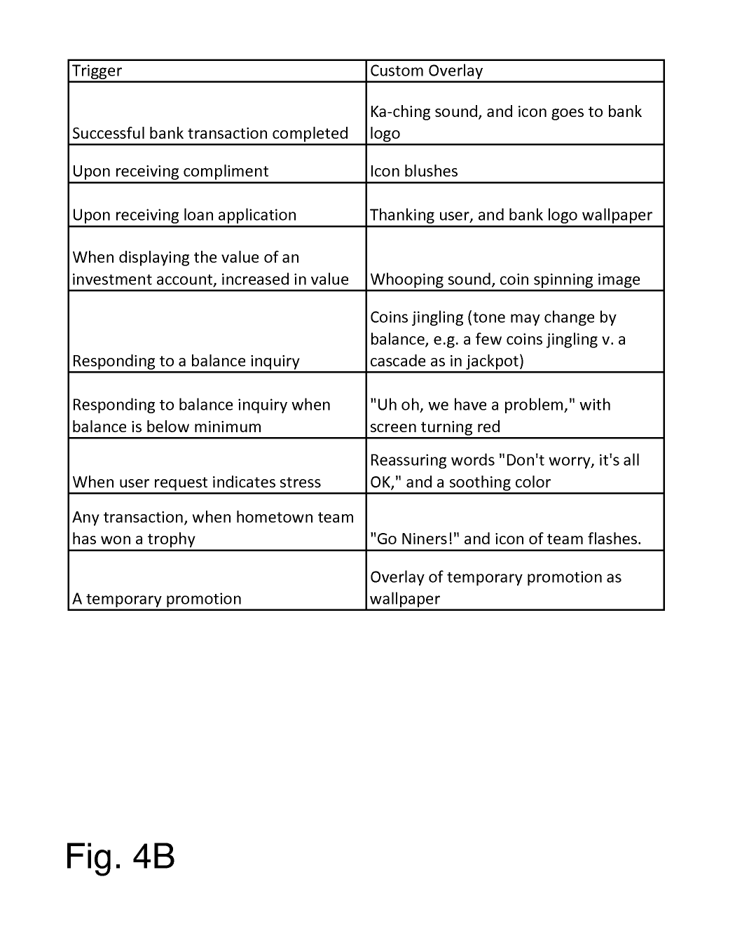

FIG. 4A is a state diagram illustrating an exemplary set of default states, and the default animations for each state. In one embodiment, the application may have five states. The first state is the “active but not listening” state 410. In one embodiment, the presence of the default icon is used to illustrate this state. In one embodiment, the default icon may be grayed out, or otherwise reduced in brightness or visibility, to indicate that the application is not listening for input.

Once activated, the application moves to the active and listening state, at block 420. In one embodiment, when the system is listening and receiving user input, the icon may flash with the user input volume. This would provide feedback to the user that the system is listening, and user input is loud enough to be recognized.

Once the user input has been received, or in one embodiment, continuously while the user input continues to be received, the application moves to the processing state 430. In one embodiment, a spinning icon indicates that the system is processing user input.

Once the processing is complete, the process moves either to responding state 440, or providing feedback state 450. The responding state 440 may be indicated with a ding to indicate that the processing has been successfully completed, and data is being provided to the user in response. The data may be interactive data, or an indication of successful completion of the processing. The process then continues to block 410, the active and not listening state, in one embodiment. In another embodiment, if the result of the processing requires further user interact, the process continues o the active and listening state 420. As noted above, this is indicated by the change in the animation provided.

If the processing was not successful, the process moves to the providing feedback state 450. In one embodiment, a tone is played to indicate incomplete processing/error/additional information request. In addition to the animation of the tone, data is provided to the user to enable the user to correct the error that lead to the incomplete result. The process then returns to the active and listening state 420.

In this way, the system moves through five states, and provides a default animation for each of the states to provide information to the user.

FIG. 4B is a diagram illustrating some exemplary custom animations available in a state. For the purposes of the example, the responding stage is selected. The responding state, as discussed in FIG. 4A has as a default response a ding to indicate successful processing. The exemplary responses shown here are for a banking application. One of skill in the art would understand that similar differentiation for various responses may be provided in other types of applications.

As shown, the custom animation trigger may be internal to the application, e.g. successful transaction, provided by the user, e.g. a compliment or other non-content communication, based on detected user characteristics such a s stress level, or entirely external to the application. In one embodiment, the custom animations may be temporary, e.g. after the hometown team of the user wins the Superbowl, or a similar trophy, for a short while the animation may incorporate a reference to this occurrence. In one embodiment, such custom animations may have an expiration date, e.g. “utilize this custom overlay for one week.”

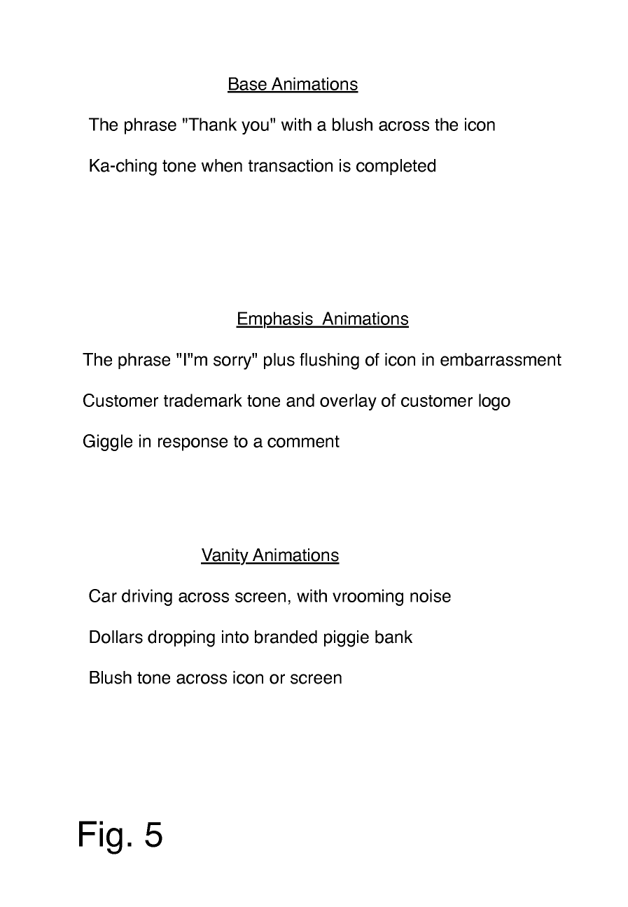

FIG. 5 illustrates some exemplary custom response types, and custom responses. In one embodiment, the response types may be divided into three categories, base animations, emphasis animations, and vanity animations. These are, of course, merely examples of potential categories, and potential animations.

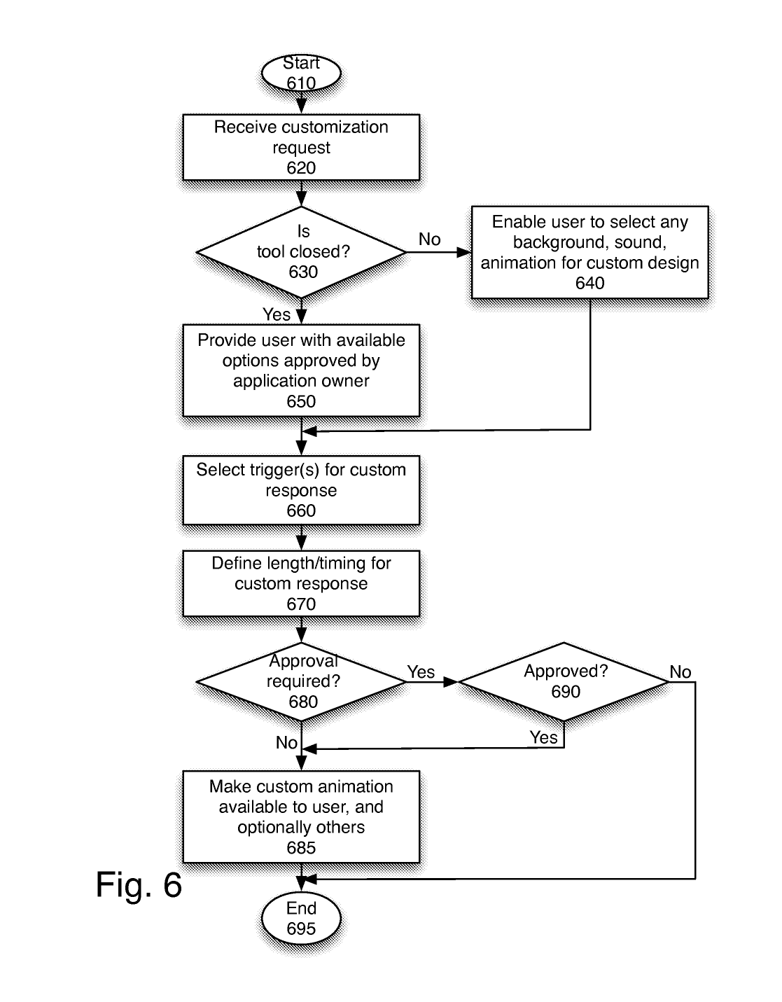

FIG. 6 is a flowchart of one embodiment of designing a custom response. In one embodiment, this tool may only be available to the owner of the application. In one embodiment, the application owner may make it available to users, or to a subset of users, for example franchise holders or other relevant subsets. The process starts at block 610, when the user accesses the custom response design system.

At block 620, the customization request is received. In one embodiment, the customization response identifies the state with which the custom response should be associated, at this stage.

At block 630, the process determines whether the tool is closed. In one embodiment, the system may limit the available options for customization. This may allow a user to customize within a limited, predefined, range. For example, a user may be allowed to select any one of a set of pre-designed wallpapers as the background, but may not add custom wallpapers beyond that set, in one embodiment. If the tool is closed, at block 650, the user is provided with the available options, as approved by the application owner. If the tool is open, at block 640, the user may select all of the features of the custom response/animation, including sounds, animations, backgrounds, etc. In one embodiment, the tool may be a mixed tool, with certain aspects being closed, while others are open. For example, the user may be able to select any overlay for the icon itself, while the set of sounds may be limited.

At block 660, the user would select one or more triggers associated with the custom response. As noted above, the triggers may include state, transaction type, transaction result (e.g. balance inquiry result may vary by the amount of balance being shown, each such result would be considered a separate custom response, in one embodiment), user stress or mood levels, temporal occurrences, or other triggers. In one embodiment, a single animation may only be associated with a single set of triggers. In another embodiment, the same animation may be associated with multiple triggers. At block 670, the timing of the custom response is defined. In one embodiment, the length of the response is limited, such that it would not interfere with the usual functioning of the application. In one embodiment, an expiration date may be set for the custom response. The expiration would indicate when the custom overlay would stop being used. This enables the creation of temporarily relevant custom overlays, for example associated with a special promotion, or a one-time event such as winning the Superbowl.

At block 680, the process determines whether making the custom response available requires application owner approval. In one embodiment, before a user may have the custom response, the application owner must approve it. In one embodiment, this may apply only to publicly shared custom animations, e.g. before uploading the custom animation to a server from which other users may obtain it. In another embodiment, the application owner may require approval of custom animations prior to allowing the user to modify his or her own application copy. This may be useful to ensure that no inappropriate custom animations become associated with the brand.

If no approval is required, at block 685, the custom animation, including the associated trigger data, is uploaded. In one embodiment, uploading may include sending it to the user's own application. In one embodiment, uploading includes making the animation available to other users. In one embodiment, if the animation is created by the application owner, making it available may include pushing the custom animation to the applications that are already installed. The process then ends at block 695.

If approval is required, at block 690, the process determines whether approval has been received. If approval is received, the process continues to block 685, to make the animation available. If no approval has been received, the process ends at block 695.

In this way, the application owner, and optionally others, can create custom animations to be used with an application. Having such custom animations increase the apparent responsiveness of an application, and increases the user interest in the application. Optionally, allowing the user to customize their own experience may also be useful to increase user engagement. Furthermore, this may provide application differentiation at a low cost to the application owner.

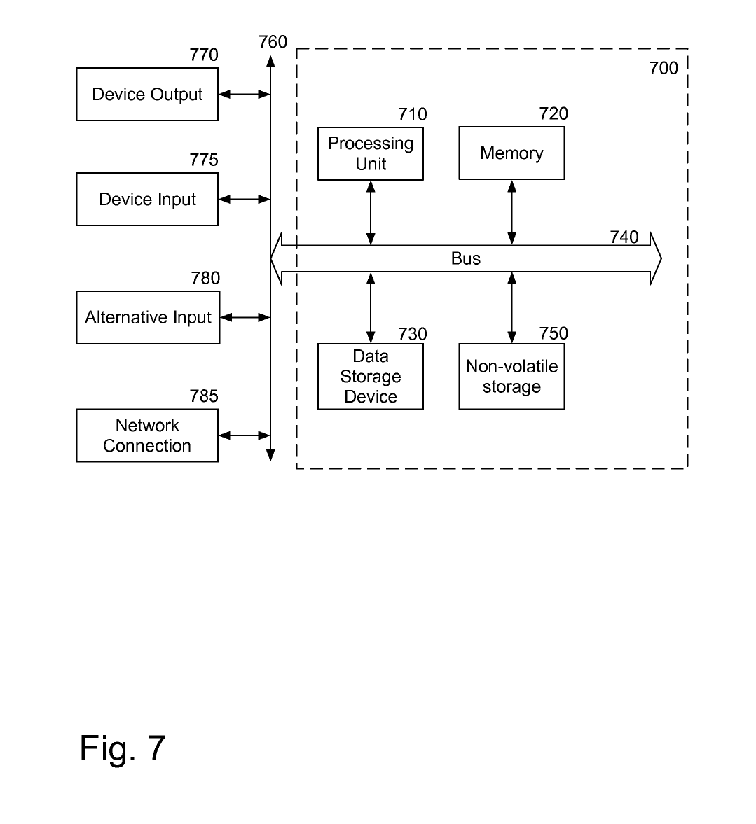

FIG. 7 is a block diagram of a particular machine that may be used with the present invention. It will be apparent to those of ordinary skill in the art, however that other alternative systems of various system architectures may also be used.

The data processing system illustrated in FIG. 7 includes a bus or other internal communication means 740 for communicating information, and a processing unit 710 coupled to the bus 740 for processing information. The processing unit 710 may be a central processing unit (CPU), a digital signal processor (DSP), or another type of processing unit 710.

The system further includes, in one embodiment, a random access memory (RAM) or other volatile storage device 720 (referred to as memory), coupled to bus 740 for storing information and instructions to be executed by processor 710. Main memory 720 may also be used for storing temporary variables or other intermediate information during execution of instructions by processing unit 710.

The system also comprises in one embodiment a read only memory (ROM) 750 and/or static storage device 750 coupled to bus 740 for storing static information and instructions for processor 710. In one embodiment the system also includes a data storage device 730 such as a magnetic disk or optical disk and its corresponding disk drive, or Flash memory or other storage which is capable of storing data when no power is supplied to the system. Data storage device 730 in one embodiment is coupled to bus 740 for storing information and instructions.

The system may further be coupled to an output device 770, such as a cathode ray tube (CRT) or a liquid crystal display (LCD) coupled to bus 740 through bus 760 for outputting information. The output device 770 may be a visual output device, an audio output device, and/or tactile output device (e.g. vibrations, etc.)

An input device 775 may be coupled to the bus 760. The input device 775 may be an alphanumeric input device, such as a keyboard including alphanumeric and other keys, for enabling a user to communicate information and command selections to processing unit 710. An additional user input device 780 may further be included. One such user input device 780 is cursor control device 780, such as a mouse, a trackball, stylus, cursor direction keys, or touch screen, may be coupled to bus 740 through bus 760 for communicating direction information and command selections to processing unit 710, and for controlling movement on display device 770.

Another device, which may optionally be coupled to computer system 700, is a network device 785 for accessing other nodes of a distributed system via a network. The communication device 785 may include any of a number of commercially available networking peripheral devices such as those used for coupling to an Ethernet, token ring, Internet, or wide area network, personal area network, wireless network or other method of accessing other devices. The communication device 785 may further be a null-modem connection, or any other mechanism that provides connectivity between the computer system 700 and the outside world.

Note that any or all of the components of this system illustrated in FIG. 7 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 720, mass storage device 730, or other storage medium locally or remotely accessible to processor 710.

It will be apparent to those of ordinary skill in the art that the system, method, and process described herein can be implemented as software stored in main memory 720 or read only memory 750 and executed by processor 710. This control logic or software may also be resident on an article of manufacture comprising a computer readable medium having computer readable program code embodied therein and being readable by the mass storage device 730 and for causing the processor 710 to operate in accordance with the methods and teachings herein.

The present invention may also be embodied in a handheld or portable device containing a subset of the computer hardware components described above. For example, the handheld device may be configured to contain only the bus 740, the processor 710, and memory 750 and/or 720.

The handheld device may be configured to include a set of buttons or input signaling components with which a user may select from a set of available options. These could be considered input device #1 775 or input device #2 780. The handheld device may also be configured to include an output device 770 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 710, a data storage device 730, a bus 740, and memory 720, and no input/output mechanisms, or only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In one embodiment, the device may not provide any direct input/output signals, but may be configured and accessed through a website or other network-based connection through network device 785.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 710. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method of providing a custom response in conjunction with an application providing speech interaction, the method comprising:
determining a context of a current interaction with the user;
identifying an associated custom animation, when the associated custom animation exists, and displaying the custom animation by overlaying it over a native response of the application; and
when no custom animation exists, determining whether there is a default animation, and displaying the default animation as part of a state change of the application.

2. The method of claim 1, wherein the custom animation comprises non-content communications with the user including one or more of visual, auditory, haptic output.

3. The method of claim 1, wherein the context comprises a recognized state, activity completion, activity request, or processing result.

4. The method of claim 1, wherein the context includes a user's stress level, in connection with the current interaction.

5. The method of claim 1, wherein the custom animations comprise one or more of base animations, emphasis animations, and vanity animations.

6. The method of claim 1, further comprising:
providing a downloadable custom animations.

7. The method of claim 6, wherein the downloadable set of animations may be brand-focused animations.

8. A method of providing a custom animation framework comprising:
defining a plurality of states of an application providing a speech interface;
associating default animations for each of the plurality of states;
defining at least one custom animation, the custom animation associated with a combination of a particular state and context data, the custom animation an overlay covering the default animation associated with the particular state;
thereby enabling use of the custom animation without defining additional states for the application.

9. The method of claim 8, further comprising;
providing an editor to enable construction of the custom animation, and definition of the states and contexts associated with the animation.

10. The method of claim 8, wherein the custom animation comprises non-content communications with the user including one or more of visual, auditory, haptic output.

11. The method of claim 8, wherein the context comprises a recognized state, activity completion, activity request, or processing result.

12. The method of claim 8, wherein the context includes a user's stress level, in connection with the current interaction.

13. The method of claim 8, wherein the custom animations comprise one or more of base animations, emphasis animations, and vanity animations.

14. The method of claim 8, further comprising:
providing a downloadable custom animations.

15. A custom animation framework comprising:
a state logic defining a plurality of states of an application providing a speech interface;
a baseline response system having default animations for each of the plurality of states;
a custom overlay system having at least one custom animation, the custom animation associated with a combination of a particular state and context data, the custom animation an overlay covering the default animation associated with the particular state;
thereby enabling use of the custom animation without defining additional states for the application.

16. The framework of claim 15, further comprising;
an animation creation system to enable construction of the custom animation, and definition of the states and contexts associated with the animation.

17. The framework of claim 15, wherein the custom animation comprises non-content communications with the user including one or more of visual, auditory, haptic output.

18. The framework of claim 15, wherein the context comprises one or more of: a recognized state, activity completion, activity request, processing result, and a user's stress level, in connection with the current interaction.

19. A framework of claim 15, further comprising, when the framework is in use:
a context determiner to determine a context of a current interaction with the user;
a trigger identifier to identify an associated custom animation with the context, when the associated custom animation exists;
a custom overly system to display the custom animation by overlaying it over a native response of the application.

20. The framework of claim 15, further comprising:
an animation sharing system to enable provision of downloadable custom animations.
